(19) United States
(12) Patent Application Publication
(10) Pub. No.: US 2013/0095274 A1
(43) Pub. Date: Apr. 18, 2013

(54) TEXTILES WITH ODOR-ABSORBING PROPERTIES AND METHODS FOR PRODUCING SAME

(71) Applicant: Dennis J. Jones, Signal Mountain, TN (US)

(72) Inventor: Dennis J. Jones, Signal Mountain, TN (US)

(21) Appl. No.: 13/274,267

(22) Filed: Oct. 14, 2011

(51) Int. Cl. C08G 69/48; D06M 15/59; D06M 15/507; C08G 63/88; B32B 3/02

(52) U.S. Cl. 428/85; 524/608; 524/605; 252/8.62

(57) ABSTRACT

In one aspect, the invention relates to fibers treated with or formed from at least one odor-absorbing composition, fiber treatment compositions, fiber treatment kits, and articles produced therefrom. In a further aspect, the invention relates to methods of increasing odor absorbency properties in a fiber. In still a further aspect, the fiber treatment compositions comprise an aqueous composition having a pH of less than about 2.1 and at least one anionic binding agent or fluorochemical. Is a further aspect, the fiber treatment compositions comprise an aqueous composition to provide a residual fiber pH of less than about 5.75 and at least one anionic binding agent or fluorochemical. This abstract is intended as a scanning tool for purposes of searching in the particular art and is not intended to be limiting of the present invention.

### CROSS-REFERENCE TO RELATED APPLICATIONS

This application claims the benefit of U.S. Application No. 61/165,180, filed Oct. 15, 2010; which is hereby incorporated herein by reference in its entirety.

### BACKGROUND

Carpets are conventionally installed in environments where they can be exposed to a variety of odors, such as cigarette smoke, pet odors, and the like. Although the application of deodorants or odor-absorbing chemicals to carpet and textiles to reduce these odors is known, these chemicals have disadvantages. For example, the conventional odor-absorbing chemicals can be removed from the carpet by washing and, thus, lose their odor-absorbing properties. In another example, the application of conventional odor-absorbing chemicals to carpet can interfere with stain and soil resist treatments. Thus, the application of these chemicals can make the carpet more susceptible to staining and soiling, and can make the carpet more difficult to clean.

Therefore, there remains a need for methods and compositions that overcome these deficiencies and that effectively provide odor-absorbing properties to textiles that are long lasting and that do not interfere with the effectiveness of stain and soil resist treatments.

### SUMMARY

In accordance with the purpose(s) of the invention, as embodied and broadly described herein, the invention, in one aspect, relates to fiber treatment compositions, fibers and articles produced therefrom, and methods for producing same.

Disclosed are fiber treatment compositions comprising an aqueous composition with one or more acids present in an amount to provide a pH of less than about 2.1, and one or more anionic binding agents, wherein a fluorochemical is not present in the composition.

Also disclosed are fiber treatment compositions comprising an aqueous composition with one or more acids present in an amount to provide a pH of less than about 2.1, and one or more fluorochemicals, wherein an anionic binding agent is not present in the composition.

Also disclosed are fiber treatment kits comprising an aqueous composition with one or more non-degradative acids present in an amount to provide a pH of less than about 2.1 and one or more anionic binding agents, and a separate aqueous composition comprising at least one fluorochemical.

Also disclosed are methods of increasing odor absorbency properties in a fiber, the methods comprising the step of treating the fiber with an aqueous composition having one or more acids present in an amount to provide a pH of less than about 2.1, wherein a fluorochemical is not present in the composition.

Also disclosed are methods of increasing odor absorbency properties in a fiber, the methods comprising the step of treating the fiber with an aqueous composition having one or more acids present in an amount to provide a pH of less than about 2.1, wherein an anionic binding agent is not present in the composition.

Also disclosed are fiber treatment compositions comprising an aqueous composition with one or more acids present in an amount to provide a residual fiber pH of less than about 5.75, and one or more anionic binding agents, wherein a fluorochemical is not present in the composition.

Also disclosed are fiber treatment compositions comprising an aqueous composition with one or more acids present in an amount to provide a residual fiber pH of less than about 5.75, and one or more fluorochemicals, wherein an anionic binding agent is not present in the composition.

Also disclosed are fiber treatment kits comprising an aqueous composition with one or more acids present in an amount to provide a residual fiber pH of less than about 5.75 and one or more anionic binding agents, and a separate aqueous composition comprising at least one fluorochemical.

Also disclosed are methods of increasing odor absorbency properties in a fiber, the methods comprising the step of treating the fiber with an aqueous composition having one or more acids present in an amount to provide a residual fiber pH of less than about 5.75, wherein a fluorochemical is not present in the composition.

Also disclosed are methods of increasing odor absorbency properties in a fiber, the methods comprising the step of treating the fiber with an aqueous composition having one or more acids present in an amount to provide a residual fiber pH of less than about 5.75, wherein an anionic binding agent is not present in the composition.

Also disclosed are methods of increasing odor absorbency properties in a carpet, the method comprising the step of treating the carpet with an aqueous composition having one or more acids present in an amount to provide a residual fiber pH of less than about 5.75, wherein the carpet is installed carpet.

Also disclosed are the products of the disclosed methods.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 is a chart comparing the rate of odor absorbency of untreated nylon fibers with nylon fibers treated with acids having varied pH.

FIG. 2 is a chart comparing the rate of odor absorbency of untreated nylon fibers with treated nylon fibers.

FIG. 3 is a chart comparing the rate of odor absorbency of treated nylon fibers formed into carpets having varied weights and constructions.

FIG. 4 is a chart comparing the rate of odor absorbency of treated nylon fibers before and after five hot water extraction cleanings.

FIG. 5 is a chart comparing the rate of odor absorbency of treated nylon fibers, untreated nylon fibers, and untreated PTT fibers.

FIG. 6 is a chart comparing the rate of odor absorbency of treated nylon fibers, and untreated PET fibers.

FIG. 7 is a chart comparing the rate of odor absorbency of treated nylon fibers, untreated PET fibers, and treated PET fibers.

FIG. 8 is a chart comparing the rate of odor absorbency of treated nylon fibers, and untreated polypropylene fibers formed into both cut pile and loop pile carpet.

FIG. 9 is a chart comparing the rate of odor absorbency of treated nylon fibers, treated PET fibers, and treated polypropylene fibers.

FIG. 10 shows the effect of fiber residual pH on pyridine concentration as a function of exposure time.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

Although any methods and materials similar or equivalent to those described herein can be used in the practice or testing of the present invention, example methods and materials are now described.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a composition,” “a fiber,” or “a step” includes mixtures of two or more such functional compositions, fibers, steps, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or can not occur, and that the description includes instances where said event or circumstance occurs and instances where it does not.

As used herein, the term “effective amount” refers to an amount that is sufficient to achieve the desired result or to have an effect on an undesired condition.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “non-degradative acid” when used in connection with fiber, refers to an acid that lowers pH without impairing the physical structure or function of the fiber. Examples include urea sulfate and sulfamic acid.

As used herein, the term “anionic binding agent” when used in connection with fiber, refers to agents that function by blocking the negative charges on the fibers so as to prevent an acid from binding to the fibers. Examples include sulfonated aromatic aldehyde condensation polymers (“SAC”) and methacrylate type anionic polymers, such as Leukotan 1028 commercially available from Rohm & Haas.

As used herein, the term “fluorochemical” refers to a compound containing fluorine, such as a fluorocarbon. The fluorochemical can be a polymeric or a nonpolymeric fluorochemical. Examples include telomeric fluorochemicals and electrochemically fluorinated fluorochemicals, such as Daikin TG 3530, TG 472 and TG 3361 and WSFR sold by Peach State Labs.

As used herein, the term “stain resist agent” when used in connection with fiber, refers to an agent that blocks dye sites on the fiber, thus preventing or reducing staining by acid dyes. Examples include FX-668F stain resist composition from 3M Specialty Chemicals Division, and phenolic type stain resist compound sold by Sybron Chemicals, Inc. under the designation “Tanatex Stainfree.”

As used herein, the term “acid retention agent” refers to a substance that can be combined with a fiber, thereby increasing the fiber's affinity for acid. That is, the fiber/agent affinity can have a lower pH (e.g., less than 2.1, 2.0, 1.9, 1.8, etc.) than the fiber in the absence of the agent. Examples include ion-exchange resins. An ion-exchange resin or ion-exchange polymer is typically an insoluble or sparingly soluble matrix, fabricated from an organic polymer substrate. The material can have highly developed structure of pores which can trap and release ions. The trapping of ions takes place only with simultaneous releasing of other ions; thus the process is called ion-exchange. There are multiple different types of ion-exchange resin which are fabricated to selectively prefer one or several different types of ions. Examples include strongly acidic (sulfonic acid groups, e.g. sodium polystyrene sulfonate or polyAMPS) and weakly acidic (carboxylic acid groups).

As used herein, residual fiber pH refers to the pH of the fiber after being treated as described herein. The residual fiber pH can be measured, for example, by placing dry fibers into an aqueous solution having a pH of about 7 (e.g., deionized water, pH 7.0) and mixing the fibers into the solution to wet the fibers. The fibers and solution can be heated to a temperature of about 180-190° F. and then cooled to a temperature of about 100° F. or less, The pH of the aqueous solution/fibers can be measured using a pH probe. Examples of fibers include those fibers having a residual pH of less than about 5.75, less than about 5.5, less than about 5.0, less than about 4.5, less than about 4.0, less than about 3.5, less than about 3.0, less than about 2.5, less than about 2.1, less than about 1.5, less than about 1.0, or less than about 0.5.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. ODOR ABSORPTION

In one aspect, the invention relates to fibers treated with or formed from at least one odor-absorbing composition. For example, fiber treated with an odor-absorbing agent can be tufted into a carpet capable of absorbing odors, such as cigarette smoke. In a further example, a carpet can be treated with an odor-absorbing agent so that the carpet is capable of absorbing odors.

It is understood that the disclosed compositions, mixtures, and fibers can be employed in connection with the disclosed fibers, methods, and uses.

1. Fibers

In one aspect, the invention relates to fibers extruded from polyester. For example, the fibers can be extruded from polyethylene terephthalate (PET), polytrimethylene terephthalate (PTT), and the like. In a further aspect, the invention relates to fibers extruded from polyolefin. In a still further aspect, the invention relates to fibers extruded from nylon. For example, the fibers can be extruded from nylon 6, nylon 6,6 and the like. In a further aspect, the invention relates to fibers extruded from polypropylene. In a further aspect, the invention relates to fibers extruded from other synthetic materials, or fibers formed from natural materials such as cotton, wool, and the like. In still a further aspect, the invention relates to fibers formed from polyester, polyolefin, polypropylene, nylon, or any combination thereof.

2. Mixtures and Compositions—Aqueous Composition

In one aspect, the invention relates to fiber treatment compositions comprising an aqueous composition with one or more acids present in an amount to provide a pH of less than about 2.1 and one or more anionic binding agents, wherein a fluorochemical is not present in the composition. In a further aspect, the invention relates to fiber treatment compositions comprising an aqueous composition with one or more non-degradative acids present in an amount to provide a pH of less than about 2.1 and one or more anionic binding agents, wherein a fluorochemical is not present in the composition. For example, the one or more anionic binding agents can comprise at least one stain resist agent. In a further example, the fluorochemical can be a fluoropolymer. In a further aspect, the invention relates to fiber treatment compositions comprising one or more anionic binding agents, wherein a fluorochemical is not present in the composition, and one or more acids present in an amount to provide a pH of less than about 2.0, less than about 1.9, less than about 1.8, less than about 1.7, less than about 1.6, less than about 1.5, less than about 1.4, less than about 1.3, less than about 1.2, less than about 1.1, or less than about 1.0.

In one aspect, the invention relates to fiber treatment compositions comprising an aqueous composition with one or more acids present in an amount to provide a pH of less than about 2.1 and one or more fluorochemicals, wherein an anionic binding agent is not present in the composition. In a further aspect, the invention relates to fiber treatment compositions comprising an aqueous composition with one or more non-degradative acids present in an amount to provide a pH of less than about 2.1 and one or more fluorochemicals, wherein an anionic binding agent is not present in the composition. For example, the one or more anionic binding agents can comprise at least one stain resist agent. In a further example, the fluorochemical can be a fluoropolymer. In a further aspect, the invention relates to fiber treatment compositions comprising one or more fluorochemicals, wherein an anionic binding agent is not present in the composition, and one or more acids present in an amount to provide a pH of less than about 2.0, less than about 1.9, less than about 1.8, less than about 1.7, less than about 1.6, less than about 1.5, less than about 1.4, less than about 1.3, less than about 1.2, less than about 1.1, or less than about 1.0.

In one aspect, the aqueous composition comprises an aqueous bath. In a further aspect, the fiber treatment compositions can further comprise at least one acid retention agent in the aqueous composition. The at least one acid retention agent can be, for example and without limitation, an ion exchange resin. In still a further aspect, the acid can comprise urea sulfate. In a further aspect, the acid can comprise sulfamic acid.

In a further aspect, the fiber treatment compositions can further comprise at least one acid retention agent. For example, if the fiber is not a nylon fiber, the composition can further comprise at least one acid retention agent.

In on aspect, the pH of the fiber treatment composition can be between about 0.5 to and 2.1. In a further aspect, the pH of the fiber treatment composition can be less than about 2.1, 2.0, 1.9, 1.8, 1.7, 1.6, 1.5, 1.4, 1.3, 1.2, 1.1, or 1.0.

3. Mixtures and Compositions—Fiber

In one aspect, the invention relates to fiber treatment compositions comprising an aqueous composition with one or more acids present in an amount to provide a residual fiber pH of less than about 5.75 and one or more anionic binding agents, wherein a fluorochemical is not present in the composition. In a further aspect, the invention relates to fiber treatment compositions comprising an aqueous composition with one or more non-degradative acids present in an amount to provide a residual fiber pH of less than about 5.75 and one or more anionic binding agents, wherein a fluorochemical is not present in the composition. In still a further aspect, the residual fiber pH can be less than about 5.75, less than about 5.5, less than about 4.5, less than about 4.0, less than about 3.5, less than about 3.0, less than about 2.5, less than about 2.1, less than about 1.5, less than about 1.0, or less than about 0.5. In a further aspect, the one or more anionic binding agents can comprise at least one stain resist agent. In a further aspect, the fluorochemical can be a fluoropolymer.

In one aspect, the invention relates to fiber treatment compositions comprising an aqueous composition with one or more acids present in an amount to provide a residual fiber pH of less than about 5.75 and one or more fluorochemicals, wherein an anionic binding agent is not present in the composition. In a further aspect, the invention relates to fiber treatment compositions comprising an aqueous composition with one or more non-degradative acids present in an amount to provide a residual fiber pH of less than about 5.75 and one or more fluorochemicals, wherein an anionic binding agent is not present in the composition. In still a further aspect, the residual fiber pH can be less than about 5.75, less than about 5.0, less than about 4.5, less than about 4.0, less than about 3.5, less than about 3.0, less than about 2.5, less than about 2.1, less than about 1.5, less than about 1.0, or less than about 0.5. In a further aspect, the one or more anionic binding agents can comprise at least one stain resist agent. In a further aspect, the fluorochemical can be a fluoropolymer.

In one aspect, the aqueous composition comprises an aqueous bath. In a further aspect, the fiber treatment compositions can further comprise at least one acid retention agent in the aqueous composition. The at least one acid retention agent can be, for example and without limitation, an ion exchange resin. In still a further aspect, the acid can comprise urea sulfate. In a further aspect, the acid can comprise sulfamic acid. In an example, if the fiber is not a nylon fiber, the composition can further comprise at least one acid retention agent.

In one aspect, the fiber can be a nylon fiber, a polyolefin fiber, a polyester fiber, a polypropylene fiber, a cotton fiber, a wool fiber, or any combination thereof.

4. Fiber Treatment Kits—Aqueous Composition

In one aspect, the invention relates to fiber treatment kits comprising an aqueous composition with one or more acids present in an amount to provide a pH of less than about 2.1 and one or more anionic binding agents, and a separate aqueous composition comprising at least one fluorochemical. In a further aspect, the invention relates to fiber treatment kits comprising an aqueous composition with one or more non-degradative acids present in an amount to provide a pH of less than about 2.1 and one or more anionic binding agents, and a separate aqueous composition comprising at least one fluorochemical. In a further aspect, the invention relates to fiber treatment kits comprising an aqueous composition with one or more anionic binding agents, one or more acids present in an amount to provide a pH of less than about 2.0, less than about 1.9, less than about 1.8, less than about 1.7, less than about 1.6, less than about 1.5, less than about 1.4, less than about 1.3, less than about 1.2, less than about 1.1, or less than about 1.0, and a separate aqueous composition comprising at least one fluorochemical.

In a further aspect, a fluorochemical is not present in the composition. Alternatively, in still a further aspect, the composition can further comprise one or more fluorochemicals. In a further aspect, an anionic agent is not present in the composition. Alternatively, the composition can further comprise one or more anionic binding agents. For example, the one or more anionic binding agents can comprise at least one stain resist agent. In a further example, the fluorochemical can be a fluoropolymer.

In one aspect, the aqueous composition comprises an aqueous bath. In a further aspect, the acid can comprise urea sulfate. In still a further aspect, the acid can comprise sulfamic acid.

In one aspect, the pH of the composition of the fiber treatment kit can be between about 0.5 to 2.1. In a further aspect, the pH of the composition of the fiber treatment kit can be less than about 2.1, 2.0, 1.9, 1.8, 1.7, 1.6, 1.5, 1.4, 1.3, 1.2, 1.1, or 1.0.

5. Fiber Treatment Kits—Fiber

In one aspect, the invention relates to fiber treatment kits comprising an aqueous composition with one or more acids present in an amount to provide a residual fiber pH of less than about 5.75 and one or more anionic binding agents, and a separate aqueous composition comprising at least one fluorochemical. In a further aspect, the invention relates to fiber treatment kits comprising an aqueous composition with one or more non-degradative acids present in an amount to provide a residual fiber pH of less than about 5.75 and one or more anionic binding agents, and a separate aqueous composition comprising at least one fluorochemical. In still a further aspect, the residual fiber pH can be less than about 5.75, less than about 5.0, less than about 4.5, less than about 4.0, less than about 3.5, less than about 3.0, less than about 2.5, less than about 2.1, less than about 1.5, less than about 1.0, or less than about 0.5. In a further aspect, the one or more anionic binding agents can comprise at least one stain resist agent. In a further aspect, the fluorochemical can be a fluoropolymer.

In a further aspect, a fluorochemical is not present in the composition. Alternatively, in still a further aspect, the composition can further comprise one or more fluorochemicals. In a further aspect, an anionic agent is not present in the composition. Alternatively, the composition can further comprise one or more anionic binding agents. For example, the one or more anionic binding agents can comprise at least one stain resist agent. In a further example, the fluorochemical can be a fluoropolymer. In a further aspect, the acid can comprise urea sulfate. In a further aspect, the acid can comprise sulfamic acid.

In one aspect, the aqueous composition and/or the second aqueous composition comprise an aqueous bath.

6. Additives

The disclosed compositions and kits can further comprise one or more additives known to those of skill in the art. That is, one of skill can readily modify one or more properties of the disclosed compositions by selection and inclusion of one or more additives. As examples, the one or more additives can be selected from plasticizers, opacifiers, nucleating agents, colorants, dyes, clarifiers, diluents, wetting agents, leveling agents, UV absorbers, buffers, and/or fillers.

### C. USES

The disclosed compositions and kits exhibit utility in various articles commonly manufactured from fiber, and in particular, fibers formed from polymer compositions. In one aspect, these fibers can be employed in textile articles, including carpet. Thus, in one aspect, the invention relates to a carpet comprising a disclosed polymer composition or a disclosed fiber. In a further aspect, the invention relates to a carpet comprising a product of a disclosed process.

It is understood that the disclosed uses can be employed in connection with the disclosed fibers, compositions, methods, and mixtures.

### D. METHODS FOR PREPARING ODOR-ABSORPTIVE FIBERS

1. Aqueous Composition

In one aspect, the invention relates to a method of increasing odor absorbency properties in a fiber, the method comprising the step of treating the fiber with an aqueous composition having one or more acids present in an amount to provide a pH of less than about 2.1, wherein a fluorochemical is not present in the composition. In a further aspect, the invention relates to fiber treatment compositions comprising one or more anionic binding agents, wherein a fluorochemical is not present in the composition, and one or more acids present in an amount to provide a pH of less than about 2.0, less than about 1.9, less than about 1.8, less than about 1.7, less than about 1.6, less than about 1.5, less than about 1.4, less than about 1.3, less than about 1.2, less than about 1.1, or less than about 1.0. In a further aspect, the invention relates to a method of increasing odor absorbency properties in a fiber, the method comprising the step of treating the fiber with an aqueous composition having one or more acids present in an amount to provide a pH of less than about 2.1, wherein an anionic binding agent is not present in the composition. In a further aspect, the invention relates to fiber treatment compositions comprising one or more fluorochemicals, wherein an anionic binding agent is not present in the composition, and one or more acids present in an amount to provide a pH of less than about 2.0, less than about 1.9, less than about 1.8, less than about 1.7, less than about 1.6, less than about 1.5, less than about 1.4, less than about 1.3, less than about 1.2, less than about 1.1, or less than about 1.0. In still a further aspect, the composition can further comprise one of more anionic binding agents. In a further aspect, the anionic binding agent can be a stain resist agent. In one aspect, the aqueous composition comprises an aqueous bath.

2. Residual Fiber pH

In one aspect, the invention relates to a method of increasing odor absorbency properties in a fiber, the method comprising the step of treating the fiber with an aqueous composition having one or more acids present in an amount to provide a residual fiber pH of less than about 5.75, wherein a fluorochemical is not present in the composition. In a further aspect, the invention relates to a method of increasing odor absorbency properties in a fiber, the method comprising the step of treating the fiber with an aqueous composition having one or more acids present in an amount to provide a residual fiber pH of less than about 5.75, wherein an anionic binding agent is not present in the composition. In still a further aspect, the composition can further comprise one of more anionic binding agents. In a further aspect, the anionic binding agent can be a stain resist agent. In one aspect, the aqueous composition comprises an aqueous bath.

In still a further aspect, the residual fiber pH can be less than about 5.75, less than about 5.0, less than about 4.5, less than about 4.0, less than about 3.5, less than about 3.0, less than about 2.5, less than about 2.1, less than about 1.5, less than about 1.0, or less than about 0.5.

It is understood that the disclosed processes can be employed in connection with the disclosed fibers, compositions, mixtures, and uses.

3. Installed Carpet

In one aspect, the invention relates to a method of increasing odor absorbency properties in a carpet, the method comprising the step of treating the carpet with an aqueous composition having one or more acids present in an amount to provide a residual fiber pH of less than about 5.75, wherein the carpet is installed carpet. For example, carpet installed can have its odor absorbency properties increased by treating the carpet with an aqueous composition having one or more acids present in an amount to provide a residual fiber pH of less than about 5.75.

4. Treating

In one aspect, the step of treating the fiber with an aqueous composition comprises immersion of the fiber in the aqueous composition, slot coating the fiber with the aqueous composition, dip coating the fiber in the aqueous composition, spray coating the fiber with the aqueous composition, pad coating the fiber with the aqueous composition, or a combination thereof. In a further aspect, the step of treating the fiber with an aqueous composition comprises spray coating the fiber with the aqueous composition, foam coating the fiber with the aqueous composition, or a combination thereof.

In a further aspect, the method of increasing odor absorbency properties in a fiber further comprises the step of subsequently treating the fiber with one or more fluorochemicals. For example, after the step of treating the fiber with an aqueous composition having one or more acids present in an amount to provide a pH of less than about 2.1, wherein a fluorochemical is not present in the composition, the fiber can be treated with one or more fluorochemicals. In another example, after the step of treating the fiber with an aqueous composition having one or more acids present in an amount to provide a residual fiber pH of less than about 5.75, wherein a fluorochemical is not present in the composition, the fiber can be treated with one or more fluorochemicals. In this aspect, the step of subsequently treating the fiber with one or more fluorochemicals comprises applying the one or more fluorochemicals to the fiber by spray coating the fiber, foam coating the fiber, or a combination thereof.

In one aspect, when the fiber is not a nylon fiber, the method of increasing odor absorbency properties in a fiber further comprises treating the fiber with at least one acid retention agent. In a further aspect, the fiber can be treated with at least one acid retention agent prior to treating the fiber with the aqueous composition.

5. Heating

In one aspect, the invention relates to a method of increasing odor absorbency properties in a fiber comprising the step of subsequently heating the fiber after treating the fiber. In a further aspect, the step of subsequently heating the fiber comprises heating the fiber with steam, with desuperheated steam, by placing the fiber in a heating device such as an oven or a dyer, or any combination thereof. In a further aspect, heating the fiber comprises heating the fiber to a predetermined temperature for a predetermined length of time. For example, in one aspect, heating the fiber comprises heating the fiber to a temperature of at least 140° F. for at least 30 seconds. In a further aspect, heating the fiber comprises heating the fiber to the predetermined temperature of at least 100° F., at least 110° F., at least 120° F., at least 130° F., at least 140° F., at least 150° F., at least 160° F., at least 170° F., at least 180° F., at least 190° F., or at least 200° F. In a further aspect, heating the fiber comprises heating the fiber to the predetermined temperature for at least about 10 seconds, at least about 20 seconds, at least about 30 seconds, at least about 40 seconds, at least about 50 seconds, or at least about 60 seconds.

6. Components

In one aspect, the fiber of the method of increasing odor absorbency properties in a fiber can be formed from synthetic materials, such as polyester, polyolefin, polypropylene, nylon and the like, and natural materials, such as cotton, wool, and the like. In still a further aspect, the invention relates to fibers formed from polyester, polyolefin, polypropylene, nylon, or any combination thereof. In a further aspect, the fiber can be spun into a yarn, and the yarn can be tufted into a carpet.

Thus, in one aspect, the fiber of the methods of increasing odor absorbency properties in a fiber can be part of a carpet. In a further aspect, the fiber can be part of a carpet greige good. As can be appreciated, the carpet can be installed in a location, such as for example and without limitation, a room of a residential house. Alternatively, the carpet can be uninstalled carpet, i.e., carpet that is not installed.

In one aspect, the aqueous composition comprises an aqueous bath. In a further aspect, the one or more acids of the aqueous composition can comprise urea sulfate. In a further aspect, the one or more acids can comprise sulfamic acid. In still a further aspect, the one or more acids can cause the pH in the composition to between about 0.5 and 2.1.

In one aspect, the aqueous composition can further comprise at least one acid retention agent. In an example, when the fiber is not a nylon fiber, the aqueous composition can further comprise at least one acid retention agent.

In one aspect, the aqueous composition can further comprise one or more fluorochemicals.

### E. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Test Methodology

A smoke chamber test was used as a screening evaluation for the carpet's ability to absorb odor, in this case cigarette smoke. The tests were conducted by placing a 2′×2′ piece of various carpets in the bottom of a 2′×2′×2′ cubic Plexiglas chamber. A lit cigarette was then placed in the chamber and a lid of the chamber closed to create an airtight seal. A small fan was used to circulate the smoke within the chamber. Air samples were taken through a port for measurement of odors in the air, in this case, pyridine and ammonia. Measurements were taken at the initial stage where the cigarette has completed its burn and then approximately every 30 minutes afterward until the carpet had been exposed for 120 minutes to the smoke. As will be indicated below, the carpet's ability to absorb odor can be measured by the concentration of odorants remaining in the air. For example, if a carpet is capable of absorbing an odor, the concentration of that odor remaining in the air will decrease over time, as more and more of the odor becomes absorbed by the carpet.

2. Test Results—Nylon 6

After being treated in an aqueous composition as described above, the residual fiber pH was measured as nylon 6 fiber was being formed into carpet. As illustrated in Table 1, trials were run on nylon 6 fibers treated in an aqueous composition having a pH between 2.5 and 1.4. The residual fiber pH was measured after a first and second carpet rinsing, after the carpet was dried, and after a final coated backing was applied. As shown in Table 1, as the composition pH was lowered, the resultant residual fiber pH was also lowered. Also notable is that the residual fiber pH increased after rinsing the fiber with water, and with subsequent processing steps.

TABLE 1

| | | Residual Fiber pH (nylon 6 fiber) | | | |
|---|---|---|---|---|---|
| Sample | Composition | After 1^{st} | After 2^{nd} | After | After |
| ID | pH | Rinse | Rinse | Dried | Coated |
| 1 | 2.5 | 5.97 | 6.02 | 6.11 | 6.21 |
| 2 | 2.2 | 5.19 | 5.71 | 5.83 | 5.95 |
| 3 | 2.0 | 3.57 | 4.14 | 4.16 | 5.64 |
| 4 | 1.8 | 3.01 | 3.06 | 3.29 | 4.56 |
| 5 | 1.6 | 2.79 | 2.94 | 2.91 | 3.02 |
| 6 | 1.5 | 2.78 | 2.81 | 2.67 | 2.73 |
| 7 | 1.4 | 2.49 | 2.55 | 2.57 | 2.56 |

These samples were then individually placed in the smoke chamber and tested for odor absorbency. Initial pyridine and ammonia levels in the smoke chamber were 0 parts per million (ppm). 50 ml samples of the air/smoke in the smoke chamber were taken and the levels of pyridine and ammonia in the smoke chamber were recorded after the cigarette had completed its burn (time “0” in the charts below) and every 30 minutes thereafter using a Draegar tube. Each reading of the Draegar tube was converted to ppm, and all are illustrated in Tables 2-8.

TABLE 2
Sample 1- nylon 6

| | | Pyridine | | Ammonia |
|---|---|---|---|---|
| Time (min) | Reading | ppm | Reading | ppm |
| Initial | 0 | 0 | 0 | 0 |
| 0 | 12 | 30 | 14 | 35 |
| 30 | 3 | 7.5 | 5 | 12.5 |
| 60 | 2 | 5 | 3 | 7.5 |
| 90 | 2 | 5 | 2 | 5 |
| 120 | 1.5 | 3.75 | 2 | 5 |

TABLE 3
Sample 2- nylon 6

| | | Pyridine | | Ammonia |
|---|---|---|---|---|
| Time (min) | Reading | ppm | Reading | ppm |
| Initial | 0 | 0 | 0 | 0 |
| 0 | 11 | 27.5 | 12 | 30 |
| 30 | 3 | 7.5 | 5 | 12.5 |
| 60 | 2 | 5 | 3 | 7.5 |
| 90 | 2 | 5 | 2 | 5 |
| 120 | 1.5 | 3.75 | 2 | 5 |

TABLE 4
Sample 3- nylon 6

| | | Pyridine | | Ammonia |
|---|---|---|---|---|
| Time (min) | Reading | ppm | Reading | ppm |
| Initial | 0 | 0 | 0 | 0 |
| 0 | 9 | 22.5 | 10 | 25 |
| 30 | 3 | 7.5 | 4 | 10 |
| 60 | 2 | 5 | 3 | 7.5 |
| 90 | 1.5 | 3.75 | 2 | 5 |
| 120 | 1.5 | 3.75 | 2 | 5 |

TABLE 5
Sample 4- nylon 6

| | | Pyridine | | Ammonia |
|---|---|---|---|---|
| Time (min) | Reading | ppm | Reading | ppm |
| Initial | 0 | 0 | 0 | 0 |
| 0 | 12 | 30 | 14 | 35 |
| 30 | 2 | 5 | 2 | 5 |
| 60 | 2 | 5 | 2 | 5 |
| 90 | 1 | 2.5 | 1 | 2.5 |
| 120 | 11 | 2.5 | 1 | 2.5 |

TABLE 6
Sample 5- nylon 6

| | | Pyridine | | Ammonia |
|---|---|---|---|---|
| Time (min) | Reading | ppm | Reading | ppm |
| Initial | 0 | 0 | 0 | 0 |
| 0 | 10 | 25 | 10 | 25 |
| 30 | 1.5 | 3.75 | 2 | 5 |
| 60 | 1.5 | 3.75 | 1 | 2.5 |
| 90 | 0.5 | 1.25 | 0.5 | 1.25 |
| 120 | 0 | 0 | 0 | 0 |

TABLE 7
Sample 6- nylon 6

| | | Pyridine | | Ammonia |
|---|---|---|---|---|
| Time (min) | Reading | ppm | Reading | ppm |
| Initial | 0 | 0 | 0 | 0 |
| 0 | 8 | 20 | 9 | 22.5 |
| 30 | 1 | 2.5 | 0.5 | 1.25 |
| 60 | 0.5 | 1.25 | 0.5 | 1.25 |
| 90 | 0.5 | 1.25 | 0.5 | 1.25 |
| 120 | 0 | 0 | 0 | 0 |

TABLE 8
Sample 7- nylon 6

| | | Pyridine | | Ammonia |
|---|---|---|---|---|
| Time (min) | Reading | ppm | Reading | ppm |
| Initial | 0 | 0 | 0 | 0 |
| 0 | 6 | 15 | 5 | 12.5 |
| 30 | 0.5 | 1.25 | 0.5 | 1.25 |
| 60 | 0 | 0 | 0 | 0 |
| 90 | 0 | 0 | 0 | 0 |
| 120 | 0 | 0 | 0 | 0 |

As illustrated in Tables 2-8, in general, as the residual pH of the fiber decreased, the ability of the nylon 6 fiber to absorb odorants (in this case pyridine and ammonia) increased indicating that fibers having a lower residual pH can absorb odorants more effectively than fibers having a higher residual pH.

The pyridine results collected in Tables 2-8 are summarized in Table 9, and the ammonia results collected in Tables 2-8 are summarized in Table 10. As discussed above, Tables 9 and 10 illustrate that as the nylon 6 fiber pH decreased, the odor absorbency (for both pyridine and ammonia) of the samples increased.

TABLE 9

| | (Pyridine ppm) | | | | | | |
|---|---|---|---|---|---|---|---|
| Time | S1 | S2 | S3 | S4 | S5 | S6 | S7 |
| (min) | pH 5.97 | pH 5.19 | pH 3.57 | pH 3.01 | pH 2.79 | pH 2.78 | pH 2.49 |
| Initial | 0 | 0 | 0 | 0 | 0 | 0 | 0 |
| 0 | 30 | 27.5 | 22.5 | 30 | 25 | 20 | 15 |
| 30 | 7.5 | 7.5 | 7.5 | 5 | 3.75 | 2.5 | 1.25 |
| 60 | 5 | 5 | 5 | 5 | 3.75 | 1.25 | 0 |
| 90 | 5 | 5 | 3.75 | 2.5 | 1.25 | 1.25 | 0 |
| 120 | 3.75 | 3.75 | 3.75 | 2.5 | 0 | 0 | 0 |

Smoke chamber pyridine levels over time for nylon 6 samples having varied pH's.
(Note: pH of each sample is the residual fiber pH after rinsing)

TABLE 10

| | (Ammonia ppm) | | | | | | |
|---|---|---|---|---|---|---|---|
| Time | S1 | S2 | S3 | S4 | S5 | S6 | S7 |
| (min) | pH 5.97 | pH 5.19 | pH 3.57 | pH 3.01 | pH 2.79 | pH 2.78 | pH 2.49 |
| Initial | 0 | 0 | 0 | 0 | 0 | 0 | 0 |
| 0 | 35 | 30 | 25 | 35 | 25 | 22.5 | 12.5 |
| 30 | 12.5 | 12.5 | 10 | 5 | 5 | 1.25 | 1.25 |
| 60 | 7.5 | 7.5 | 7.5 | 5 | 2.5 | 1.25 | 0 |
| 90 | 5 | 5 | 5 | 2.5 | 1.25 | 1.25 | 0 |
| 120 | 5 | 5 | 5 | 2.5 | 0 | 0 | 0 |

Smoke chamber ammonia levels over time for nylon 6 samples having varied pH's.
(Note: pH of each sample is the residual fiber pH after rinsing)

3. Test Results—PET

After being treated in an aqueous composition as described above, the residual fiber pH was measured as polyethylene terephthalate (PET) fiber was being formed into carpet. As illustrated in Table 11, trials were run on PET fibers treated in an aqueous composition having a pH between 2.45 and 1.4. The residual fiber pH was measured after carpet rinsing, after the carpet was dried, and after a final coated backing was applied. As shown generally in Table 11, as the composition pH was lowered, the resultant residual fiber pH was also lowered. Also notable is that the residual fiber pH increased after rinsing the fiber with water and with subsequent processing steps.

TABLE 11

Residual Fiber pH (PET fiber)

| Sample | Composition | After | After | After |
|---|---|---|---|---|
| ID | pH | Rinse | Dried | Coated |
| 1 | 2.45 | 4.84 | 6.38 | 5.36 |
| 2 | 2.2 | 5.33 | 4.55 | 5.95 |
| 3 | 2.0 | 4.16 | 4.27 | 5.43 |
| 4 | 1.8 | 3.57 | 4.00 | 5.47 |
| 5 | 1.6 | 3.97 | 4.36 | 5.38 |
| 6 | 1.52 | 3.25 | 5.19 | 5.50 |
| 7 | 1.4 | 4.45 | 2.75 | 5.36 |

These samples were then individually placed in the smoke chamber and tested for odor absorbency. Initial pyridine and ammonia levels in the smoke chamber were 0 parts per million (ppm). 50 ml samples of the air/smoke in the smoke chamber were taken and the levels of pyridine and ammonia in the smoke chamber were recorded after the cigarette had completed its burn (time “0” in the charts below) and every 30 minutes thereafter using a Draegar tube. Each reading of the Draegar tube was converted to ppm, and all are illustrated in Tables 12-18.

TABLE 12
Sample 1- PET

| | | Pyridine | | Ammonia |
|---|---|---|---|---|
| Time (min) | Reading | ppm | Reading | ppm |
| Initial | 0 | 0 | 0 | 0 |
| 0 | 11 | 27.5 | 11 | 27.5 |
| 30 | 5 | 12.5 | 6 | 15 |
| 60 | 4 | 10 | 5 | 12.5 |
| 90 | 4 | 10 | 4 | 10 |
| 120 | 3 | 7.5 | 3 | 7.5 |

TABLE 13
Sample 2- PET

| | | Pyridine | | Ammonia |
|---|---|---|---|---|
| Time (min) | Reading | ppm | Reading | ppm |
| Initial | 0 | 0 | 0 | 0 |
| 0 | 9 | 22.5 | 8 | 20 |
| 30 | 4 | 10 | 5 | 12.5 |
| 60 | 4 | 10 | 5 | 12.5 |
| 90 | 4 | 10 | 5 | 12.5 |
| 120 | 3 | 7.5 | 4 | 10 |

TABLE 14
Sample 3- PET

| | | Pyridine | | Ammonia |
|---|---|---|---|---|
| Time (min) | Reading | ppm | Reading | ppm |
| Initial | 0 | 0 | 0 | 0 |
| 0 | 11 | 27.5 | 12 | 30 |
| 30 | 5 | 12.5 | 6 | 15 |
| 60 | 4 | 10 | 5 | 12.5 |
| 90 | 3 | 7.5 | 4 | 10 |
| 120 | 3 | 7.5 | 4 | 10 |

TABLE 15
Sample 4- PET

| | | Pyridine | | Ammonia |
|---|---|---|---|---|
| Time (min) | Reading | ppm | Reading | ppm |
| Initial | 0 | 0 | 0 | 0 |
| 0 | >14 | >35 | 17 | 42.5 |
| 30 | 8 | 20 | 10 | 25 |
| 60 | 6 | 15 | 7 | 17.5 |
| 90 | 5 | 12.5 | 5 | 12.5 |
| 120 | 4 | 10 | 4 | 10 |

TABLE 16
Sample 5- PET

| | | Pyridine | | Ammonia |
|---|---|---|---|---|
| Time (min) | Reading | ppm | Reading | ppm |
| Initial | 0 | 0 | 0 | 0 |
| 0 | 12 | 30 | 15 | 37.5 |
| 30 | 6 | 15 | 7 | 17.5 |
| 60 | 5 | 12.5 | 5 | 12.5 |
| 90 | 4 | 10 | 5 | 12.5 |
| 120 | 3 | 7.5 | 3 | 7.5 |

TABLE 17
Sample 6- PET

| | | Pyridine | | Ammonia |
|---|---|---|---|---|
| Time (min) | Reading | ppm | Reading | ppm |
| Initial | 0 | 0 | 0 | 0 |
| 0 | 12 | 30 | 14 | 35 |
| 30 | 5 | 12.5 | 5 | 12.5 |
| 60 | 4 | 10 | 5 | 12.5 |
| 90 | 3 | 7.5 | 3 | 7.5 |
| 120 | 2 | 5 | 2 | 5 |

TABLE 18
Sample 7- PET

| | | Pyridine | | Ammonia |
|---|---|---|---|---|
| Time (min) | Reading | ppm | Reading | ppm |
| Initial | 0 | 0 | 0 | 0 |
| 0 | 10 | 25 | 10 | 25 |
| 30 | 3 | 7.5 | 2 | 5 |
| 60 | 2 | 5 | 1 | 2.5 |
| 90 | 1 | 2.5 | 1 | 2.5 |
| 120 | 0.5 | 1.25 | 0.5 | 1.25 |

As illustrated in Tables 12-18, in general, as the residual pH of the PET fiber decreased, the ability of the fiber to absorb odorants (in this case pyridine and ammonia) increased indicating that fibers having a lower residual pH can absorb odorants more effectively than fibers having a higher residual pH.

The pyridine results collected in Tables 12-18 are summarized in Table 19, and the ammonia results collected in Tables 12-18 are summarized in Table 20. As discussed above, Tables 19 and 20 illustrate that as the PET fiber pH decreased, the odor absorbency (for both pyridine and ammonia) of the samples increased.

TABLE 19

| | (Pyridine ppm) | | | | | | |
|---|---|---|---|---|---|---|---|
| Time | S1 | S2 | S3 | S4 | S5 | S6 | S7 |
| (min) | pH 4.84 | pH 5.33 | pH 4.16 | pH 3.57 | pH 3.97 | pH 3.25 | pH 4.45 |
| Initial | 0 | 0 | 0 | 0 | 0 | 0 | 0 |
| 0 | 27.5 | 22.5 | 27.5 | >35 | 30 | 30 | 25 |
| 30 | 12.5 | 10 | 12.5 | 20 | 15 | 12.5 | 7.5 |
| 60 | 10 | 10 | 10 | 15 | 12.5 | 10 | 5 |
| 90 | 10 | 10 | 7.5 | 12.5 | 10 | 7.5 | 2.5 |
| 120 | 7.5 | 7.5 | 7.5 | 10 | 7.5 | 5 | 1.25 |

Smoke chamber pyridine levels over time for PET samples having varied pH's.
(Note: pH of each sample is the residual fiber pH after rinsing)

TABLE 20

| | (Ammonia ppm) | | | | | | |
|---|---|---|---|---|---|---|---|
| Time | S1 | S2 | S3 | S4 | S5 | S6 | S7 |
| (min) | pH 4.84 | pH 5.33 | pH 4.16 | pH 3.57 | pH 3.97 | pH 3.25 | pH 4.45 |
| Initial | 0 | 0 | 0 | 0 | 0 | 0 | 0 |
| 0 | 27.5 | 20 | 30 | 42.5 | 37.5 | 35 | 25 |
| 30 | 15 | 12.5 | 15 | 25 | 17.5 | 12.5 | 5 |
| 60 | 12.5 | 12.5 | 12.5 | 17.5 | 12.5 | 12.5 | 2.5 |
| 90 | 10 | 12.5 | 10 | 12.5 | 12.5 | 7.5 | 2.5 |
| 120 | 7.5 | 10 | 10 | 10 | 7.5 | 5 | 1.25 |

Smoke chamber ammonia levels over time for PET samples having varied pH's.
(Note: pH of each sample is the residual fiber pH after rinsing)

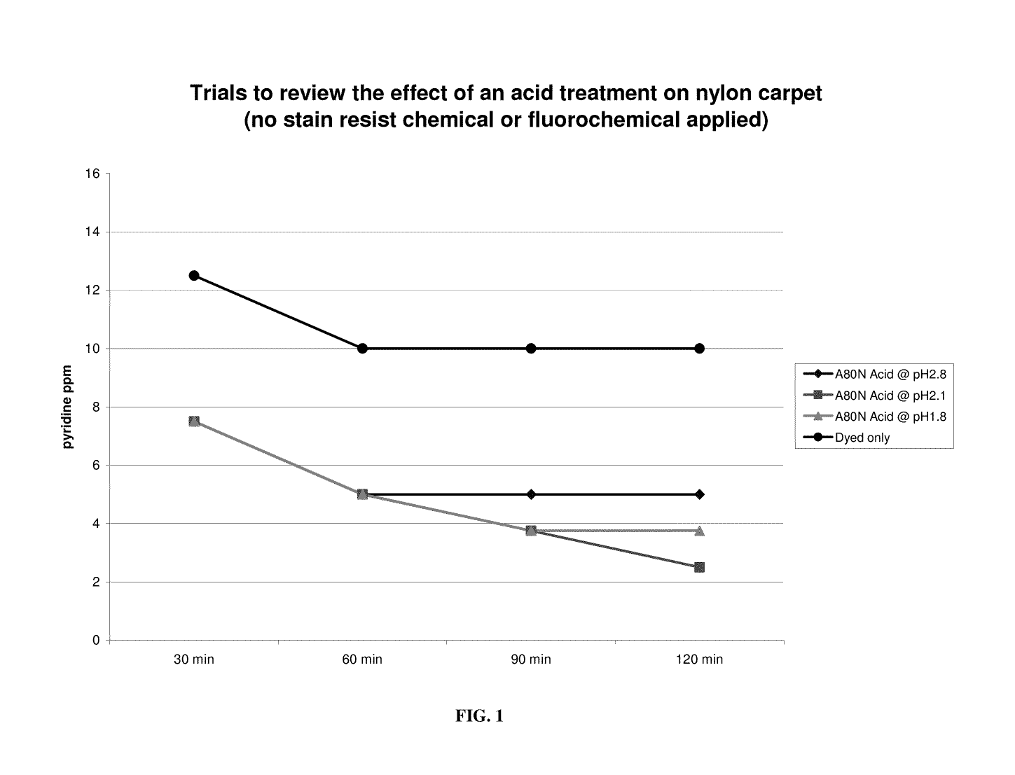

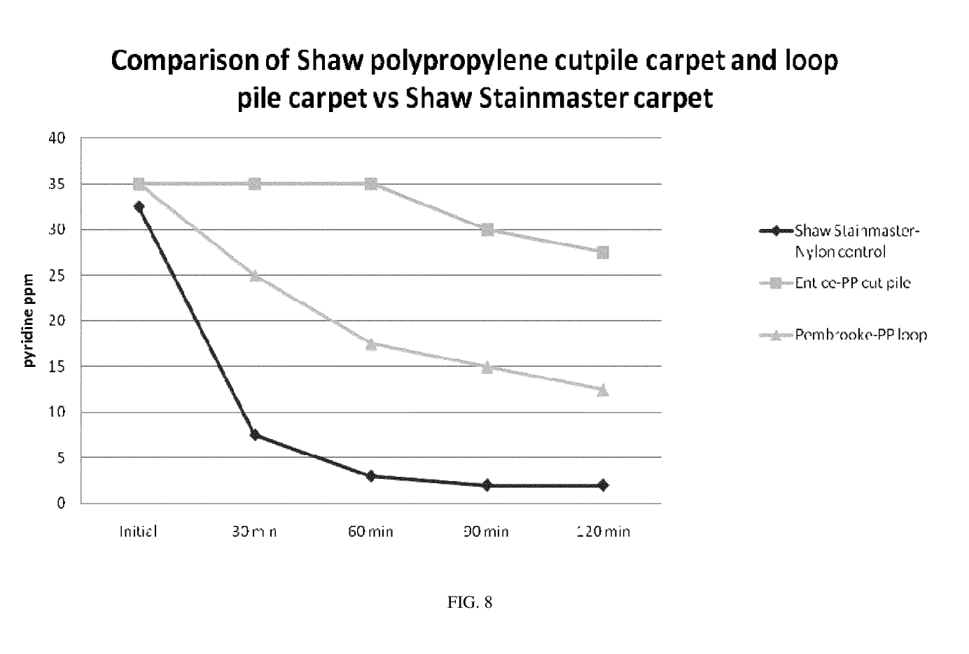

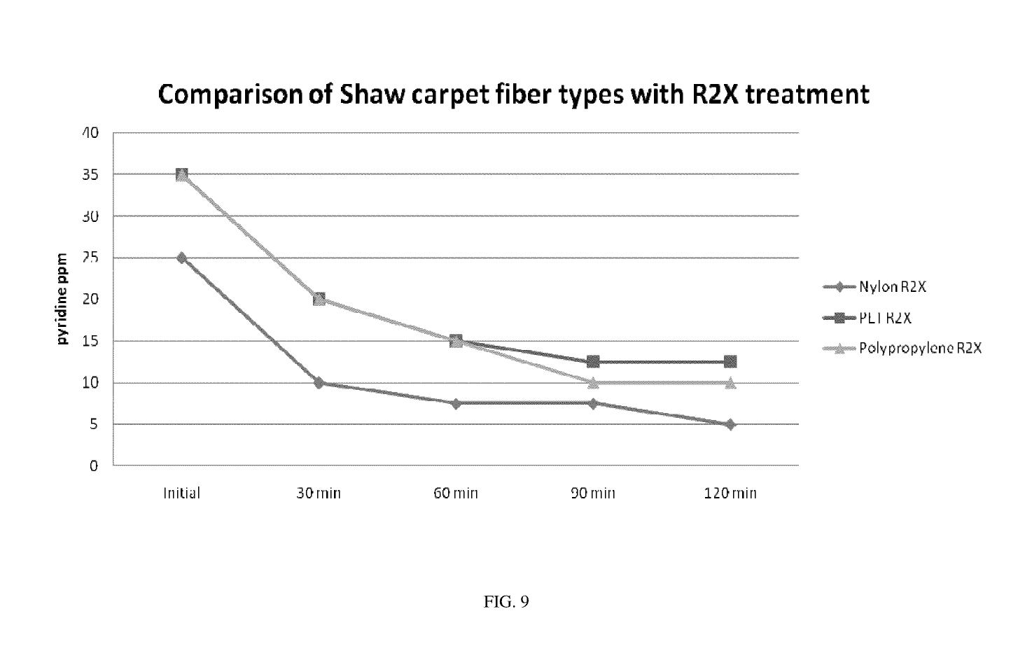

Other tests were performed on carpet formed from fibers treated as described above and tested for odor absorbency in the smoke chamber. Results of the tests are illustrated graphically in FIGS. 1-9.

As illustrated in FIG. 1, nylon fibers treated in an aqueous composition with one or more acids present in an amount to provide a pH of about 2.1 and less than about 2.1, as described above, exhibited an increased rate of absorbency when compared to nylon fibers that were dyed only and not treated. Thus, the treated nylon fibers absorbed the odorant (pyridine) at a significantly higher rate than fiber that was untreated.

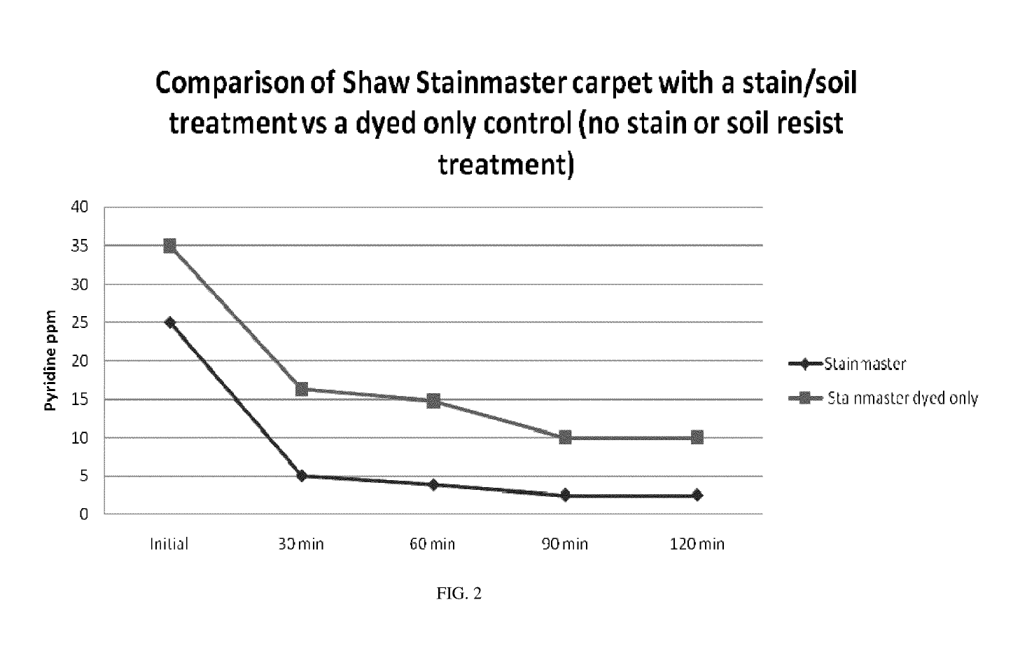

FIG. 2 illustrates the results of experiments comparing nylon fibers treated in an aqueous composition with one or more acids present in an amount to provide a residual pH of less than about 4 pH versus nylon fibers that were dyed only and not treated. The fibers in both trials were Stainmaster® brand nylon fibers produced by Invista. As can be seen, the treated fibers absorbed significantly more odors than the untreated fibers throughout the testing time range.

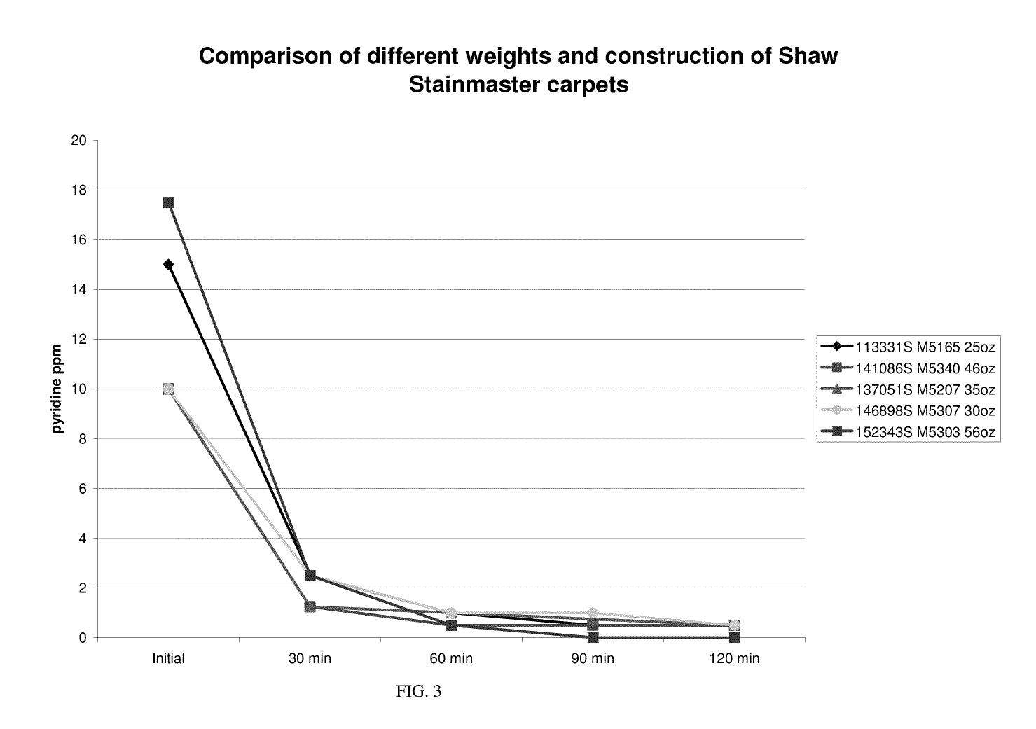

As can be seen in FIG. 3, there was no significant difference in the results between carpets having different constructions formed from treated fibers. The fibers were Stainmaster nylon fibers tufted into carpets having a face weight of about 25 ounces/square yard, 46 ounces/square yard, 35 ounces/square yard, 30 ounces/square yard, and 56 ounces/square yard. Each of these carpets absorbed odors at about the same rate.

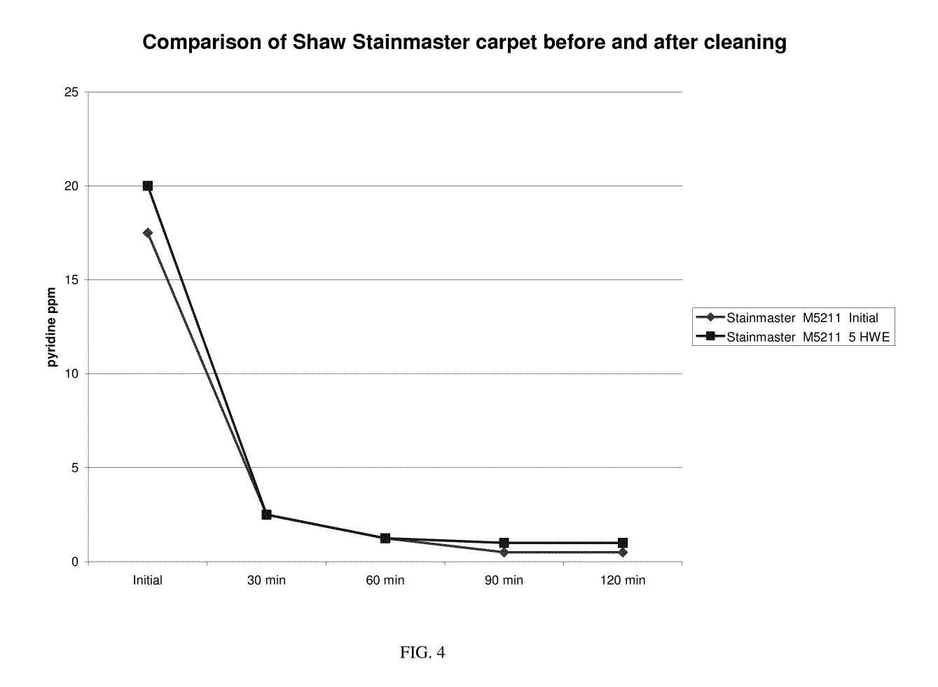

As illustrated in FIG. 4, treated Stainmaster nylon fibers retained their ability to absorb odors even after repeated hot water extraction cleanings of the carpet produced from the fibers. For example, after 5 steam cleanings, the treated fibers absorbed odors at about the same rate as the same fibers did prior to the cleanings. Thus, after installation and repeated cleanings, carpet formed from treated fiber can continue to absorb odors.

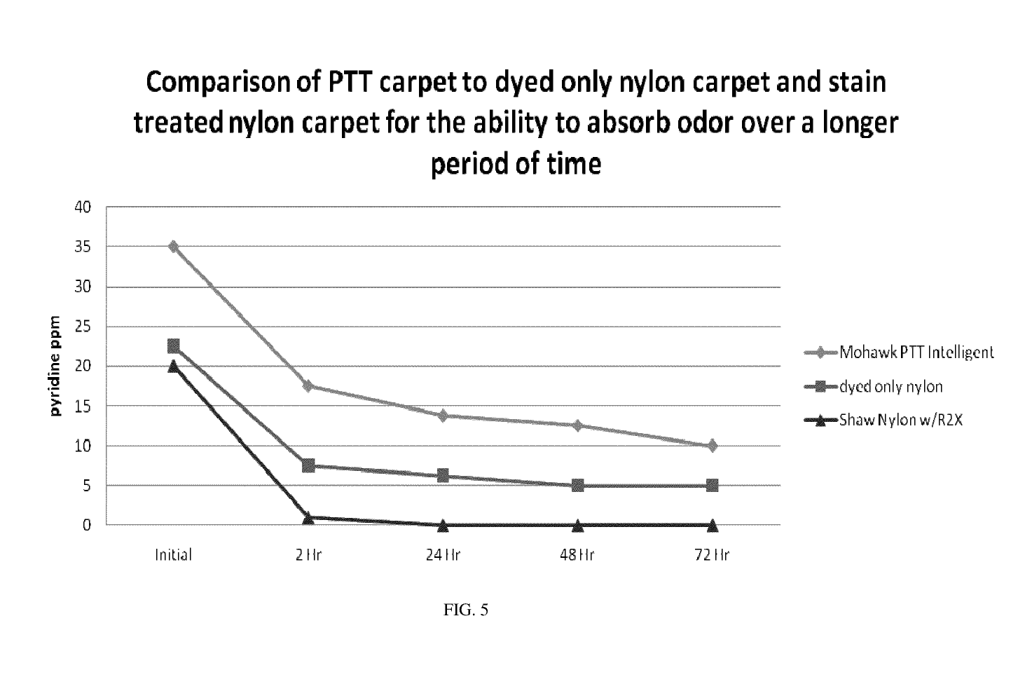

Fibers formed from polytrimethylene terephthalate (PTT) exhibited improved odor absorption capabilities after treatment as described herein, even though PTT fibers have a very low rate of absorbency. FIG. 5 compares a treated Stainmaster nylon sample, an untreated nylon sample, and a treated PTT sample. The PTT sample absorbed much more odor than an untreated PTT sample, but as can be seen, the PTT sample could not absorb as much odorant as the treated or untreated nylon fibers.

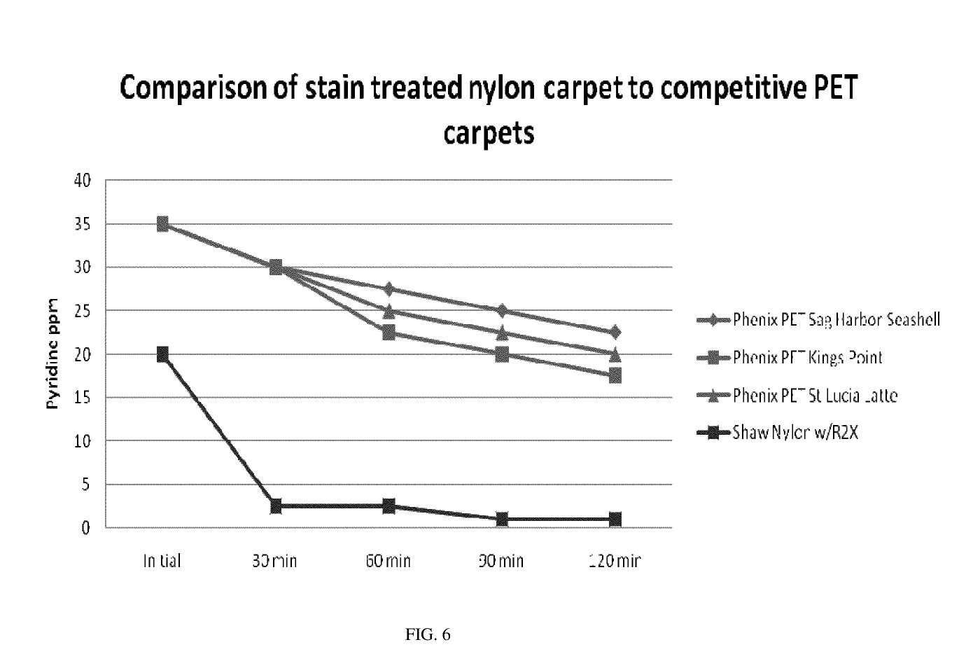

Similarly, fibers formed from polyethylene terephthalate (PET) also exhibited improved odor absorption capabilities after treatment as described herein. FIG. 6 compares a treated Stainmaster nylon sample, an untreated PET sample, and a treated PET sample. As can be seen, treating the PET fibers significantly improved their rate of absorbency when compared to untreated PET fibers. However, neither PET sample could absorb as much odorant as the nylon fibers, because competitive PET fibers have a much lower rate of absorbency than conventional nylon fibers.

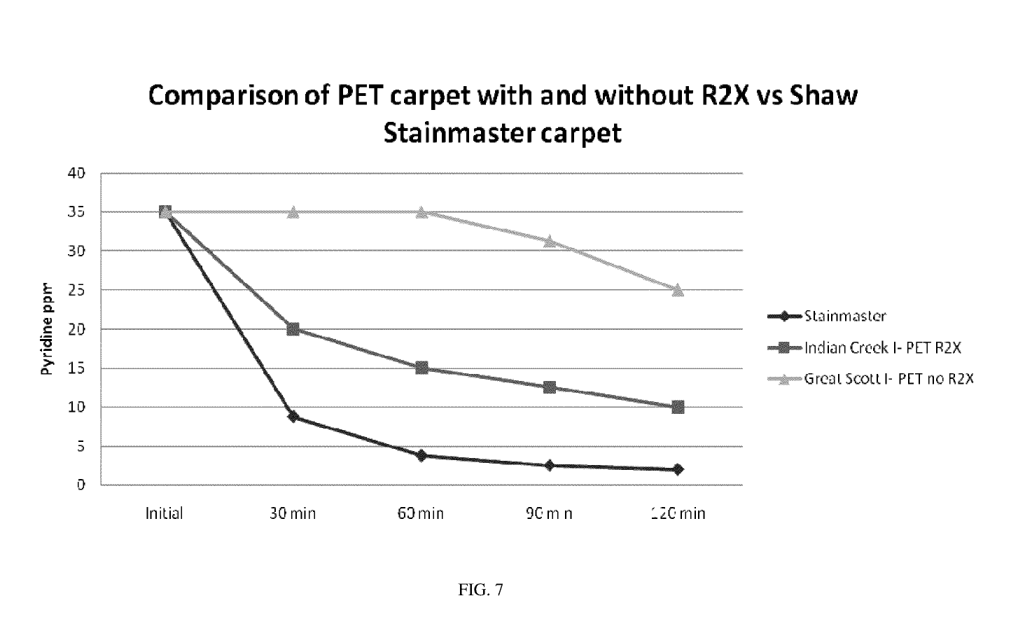

FIGS. 7-9 compare the odor absorption capabilities of three different types of treated fibers: fibers formed from nylon, PET, and polypropylene. As can be seen, nylon consistently has the highest rate of odorant absorbency compared to the PET and polypropylene. However, each treated sample showed improvement versus a respective untreated sample.

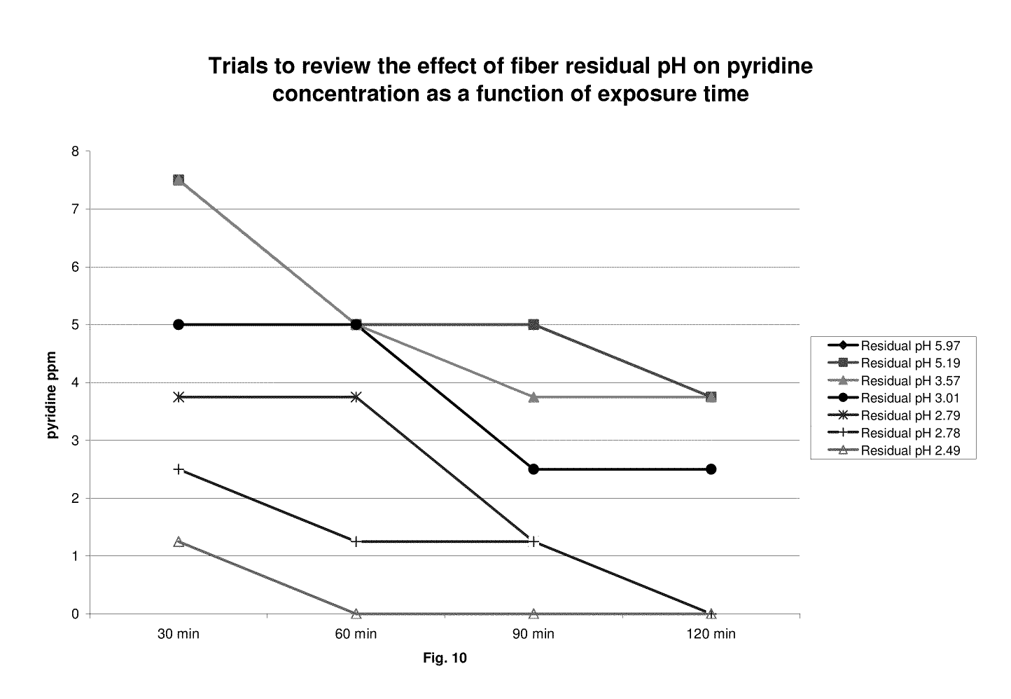

FIG. 10 shows the effect of fiber residual pH on pyridine concentration as a function of exposure time. Data were taken from Tables 1-8 and graphed to describe the relationship between residual pH and odor absorption. Experiments were conducted in a manner similar to those disclosed herein. In general, lower fiber residual pH provides greater odor absorbance (i.e., lower pyridine concentrations). For example, a fiber residual pH of less than about 3 (e.g., Samples 5-7) can provide a pyridine concentration of essentially zero after a period of time.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of increasing odor absorbency properties in a fiber, the method comprising the step of treating the fiber with an aqueous composition comprising one or more acids present in an amount to provide a composition pH of less than about 2.1, wherein a fluorochemical is not present in the composition.

2. The method of claim 1, wherein the composition further comprises one or more anionic binding agents.

3. The method of claim 2, wherein the anionic binding agent is a stain resist agent.

4. The method of claim 1, wherein the fiber is part of a carpet.

5. The method of claim 1, wherein the fiber comprises nylon.

6. The method of claim 1, wherein the fiber comprises polyester.

7. The method of claim 6, wherein the polyester comprises polytrimethylene terephthalate.

8. The method of claim 1, wherein the composition further comprises at least one acid retention agent.

9. The method of claim 1, wherein the acid comprises urea sulfate or sulfamic acid.

10. The method of claim 1, further comprising the step of subsequently heating the fiber.

11. The method of claim 10, wherein the step of heating the fiber comprises heating the fiber with desuperheated steam.

12. An odor-resistant carpet produced by the method of claim 1.

13. A method of increasing odor absorbency properties in a fiber, the method comprising the step of treating the fiber with an aqueous composition comprising one or more acids present in an amount to provide a composition pH of less than about 2.1, wherein an anionic binding agent is not present in the composition.

14. The method of claim 13, wherein the composition further comprises a fluorochemical.

15. The method of claim 14, wherein the fluorochemical is a fluoropolymer.

16. The method of claim 13, wherein the fiber comprises nylon.

17. The method of claim 13, wherein the fiber comprises polyester.

18. The method of claim 17, wherein the polyester comprises polytrimethylene terephthalate.

19. The method of claim 13, wherein the composition further comprises at least one acid retention agent.

20. The method of claim 13, further comprising the step of subsequently heating the fiber.

21. The method of claim 20, wherein the step of heating the fiber comprises heating the fiber with desuperheated steam.

22. An odor-resistant carpet produced by the method of claim 13.

23. A fiber treatment composition comprising an aqueous composition comprising one or more non-degradative acids present in an amount to provide a composition pH of less than about 2.1; and one of:
(a) one or more anionic binding agents, wherein a fluorochemical is not present in the composition; or
(b) one or more fluorochemicals, wherein an anionic binding agent is not present in the composition.

24. The composition of claim 23, wherein the one or more anionic binding agents comprises at least one stain resist agent.

25. The composition of claim 23, further comprising at least one acid retention agent.

26. The composition of claim 25, wherein the one or more fluorochemicals comprises at least one fluoropolymer.

27. An odor-resistant carpet produced from the fiber treatment composition of claim 23.
